(19) United States
(12) Patent Application Publication
(10) Pub. No.: US 2025/0310414 A1
(43) Pub. Date: Oct. 2, 2025

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventors: Yasuhiko YOSHIDA, Tokyo (JP); Rui KONDO, Tokyo (JP)

(73) Assignee: NEC Corporation, Tokyo (JP)

(21) Appl. No.: 19/069,374

(22) Filed: Mar. 4, 2025

(30) Foreign Application Priority Data
Mar. 28, 2024 (JP) 2024-053503

(51) Int. Cl. H04L 67/50; A63F 13/61

(52) U.S. Cl. CPC H04L 67/535; A63F 13/61

(57) ABSTRACT

Provided are an information processing apparatus, an information processing method, and an information processing program capable of ascertaining a contribution of each provider avatar in an event held in a metaverse. An information processing apparatus according to the present disclosure includes: a memory configured to store instructions; and a processor configured to execute the instructions to identify, in a virtual space, an interest state in which a plurality of provider avatars providing a predetermined benefit pays attention to the provider avatar in an event of providing the benefit to a beneficiary avatar receiving the benefit, aggregate the interest state for each of the provider avatars, and estimate a contribution of the provider avatar to the event based on the aggregated interest state.

### INCORPORATION BY REFERENCE

This application is based upon and claims the benefit of priority from Japanese patent application No. 2024-053503, filed on Mar. 28, 2024, the disclosure of which is incorporated herein in its entirety by reference.

### TECHNICAL FIELD

The present disclosure relates to an information processing apparatus, an information processing method, and an information processing program.

### BACKGROUND ART

In recent years, advertisement business in the metaverse has attracted attention. For example, Japanese Unexamined Patent Application Publication No. 2021-193542 discloses a technology in which a user experiences a virtual space via an avatar that is a virtual self of the user and displays an advertisement to the user in a metaverse.

### SUMMARY

When a plurality of provider avatars provide a predetermined benefit in an event held in a metaverse, it is required to distribute advertisement fees according to a contribution of each provider avatar in the event. However, it has been difficult to appropriately ascertain the contribution of each provider avatar in an event.

Accordingly, the present disclosure has been made to solve such a problem, and an example object of the present disclosure is to provide an information processing apparatus, an information processing method, and an information processing program capable of ascertaining a contribution of each provider avatar in an event held in a metaverse.

An information processing apparatus according to a first example aspect of the present disclosure includes:
an identifying unit configured to identify, in an event in which a plurality of provider avatars providing a predetermined benefit in a virtual space provide the benefit to a beneficiary avatar receiving the benefit, an interest state in which the beneficiary avatar pays attention to the provider avatar;
an aggregation unit configured to aggregate the interest state for each of the provider avatars; and
an estimation unit configured to estimate a contribution of the provider avatar to the event based on the aggregated interest state.

An information processing method according to a second example aspect of the present disclosure includes:
identifying, in event in which a plurality of provider avatars providing a predetermined benefit in a virtual space provide the benefit to a beneficiary avatar receiving the benefit, an interest state in which the beneficiary avatar is paying attention to the provider avatar, by a computer;
aggregating the interest state for each of the provider avatars by the computer; and
estimating a contribution of the provider avatar to the event based on the interest states aggregated by the computer.

An information processing program according to a third example aspect of the present disclosure causes a computer to perform:
a process of identifying, in an event in which a plurality of provider avatars providing a predetermined benefit in a virtual space provide the benefit to a beneficiary avatar receiving the benefit, an interest state in which the beneficiary avatar pays attention to the provider avatar;
a process of aggregating the interest state for each of the provider avatars; and
a process of estimating a contribution of the provider avatar to the event based on the aggregated interest state.

According to the present disclosure, it is possible to provide the information processing apparatus, the information processing method, and the information processing program capable of ascertaining a contribution of each provider avatar in an event held in a metaverse.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration example of an information processing apparatus according to the present disclosure;

FIG. 2 is a flowchart illustrating an example of a flow of an information processing method according to the present disclosure;

FIG. 3 is a block diagram illustrating a configuration example of an information processing system in which the information processing apparatus is used according to the present disclosure;

FIG. 4 is a block diagram illustrating a configuration example of a metaverse operating system;

FIG. 5 is a block diagram illustrating a configuration example of an information processing apparatus according to the present disclosure;

FIG. 6 is a flowchart illustrating an example of a flow of an information processing method according to the present disclosure;

FIG. 7 is a diagram illustrating an example of a field of view of interest;

FIG. 8 is a diagram illustrating an example of a field of view of interest;

FIG. 9 is a flowchart illustrating an example of a flow of an information processing method according to the present disclosure; and

FIG. 10 is a block diagram illustrating a hardware configuration of a computer.

### EXAMPLE EMBODIMENT

### First Example Embodiment

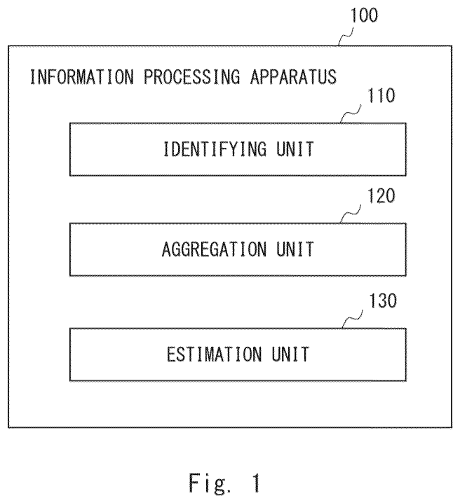

A configuration example of an information processing apparatus 100 according to the present disclosure will be described with reference to FIG. 1. As illustrated in FIG. 1, the information processing apparatus 100 includes an identifying unit 110, an aggregation unit 120, and an estimation unit 130. The information processing apparatus 100 is an information processing apparatus that estimates a contribution in an event by a provider avatar based on an interest state of a beneficiary avatar in an event held in a virtual space such as a metaverse.

The metaverse is a virtual space constructed on a network such as the Internet. In the metaverse, each user acts using an avatar that is a virtual self of the user. The provider avatar provides a predetermined benefit in an event held in the virtual space. For example, the provider avatar is a presenter who manages an event held in the virtual space, a performer who performs a program in the event, or the like. The beneficiary avatar receives a certain benefit provided by the provider avatar at an event held in the virtual space. For example, the beneficiary avatar is a participant in the event held in the virtual space, or the like.

The identifying unit 110 identifies an interest state of the beneficiary avatar. The interest state is a state in which a beneficiary avatar is paying attention to a provider avatar. The identifying unit 110 identifies whether the beneficiary avatar is paying attention to the provider avatars and to which provider avatar the beneficiary avatar is paying attention. When a plurality of beneficiary avatars participate in an event, the identifying unit 110 identifies an interest state for each of the plurality of beneficiary avatars.

The aggregation unit 120 aggregates the interest state identified by the identifying unit 110 for each provider avatar. For example, the aggregation unit 120 may calculate, for each of the provider avatars, a total time in which the beneficiary avatar has paid attention to each of the provider avatars. When a plurality of the beneficiary avatars participates in an event, the aggregation unit 120 aggregates the interest state of each of the beneficiary avatars for each of the provider avatars.

The estimation unit 130 estimates a contribution of each provider avatar to an event based on the interest state aggregated by the aggregation unit 120. For example, the estimation unit 130 may estimate that the contribution to the event is high for the provider avatar for which a total time of the aggregated interest state is long.

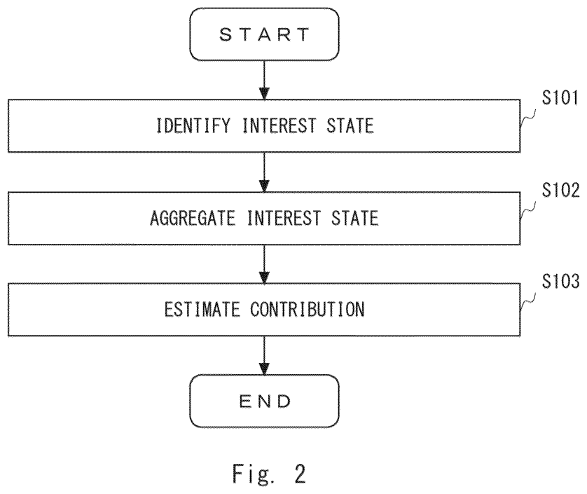

Next, an example of an operation of the information processing apparatus 100, that is, an example of an information processing method according to the present disclosure will be described with reference to FIG. 2. First, the identifying unit 110 identifies an interest state in which the beneficiary avatar pays attention to the provider avatar in the event held in the virtual space (step S101). Subsequently, the aggregation unit 120 aggregates the interest state identified in step S101 for each provider avatar (step S102). Subsequently, the estimation unit 130 estimates a contribution of each provider avatar to the event based on the interest state aggregated in step S102 (step S103). As described above, in the information processing method according to the present disclosure, the contribution to the event is estimated for each provider avatar based on the interest state aggregated for each provider avatar. Therefore, a reward can be distributed to each provider according to the contribution.

The information processing apparatus 100 includes a processor, a memory, and a storage device as components (not illustrated). The storage device stores a computer program in which processing of an information processing method according to the present disclosure is implemented. Then, the processor reads a computer program from the storage device to the memory and executes the computer program. Accordingly, the processor implements functions of the identifying unit 110, the aggregation unit 120, and the estimation unit 130.

Alternatively, each component of the information processing apparatus 100 may be implemented by dedicated hardware. Some or all of components of each apparatus may be implemented by a general-purpose or dedicated circuitry, a processor, or the like, or a combination thereof. These components may be configured with a single chip or may be configured with a plurality of chips connected via a bus. Some or all of components of each apparatus may be implemented by combining the above-described circuit or the like and a program. As the processor, a central processing unit (CPU), a graphics processing unit (GPU), a field-programmable gate array (FPGA), a quantum processor (quantum computer control chip), or the like can be used.

When some or all of the components of the information processing apparatus 100 are implemented by a plurality of information processing apparatuses, circuits, and the like, and the plurality of information processing apparatuses, circuits, and the like may be arrayed in a centralized manner or in a distributed manner. For example, the information processing apparatus, the circuit, and the like may be implemented as a form in which each is connected via a communication network, such as a client server system and a cloud computing system. A function of the information processing apparatus 100 may be provided in software as a service (SaaS) format.

### Second Example Embodiment

A second example embodiment is a more specific embodiment.

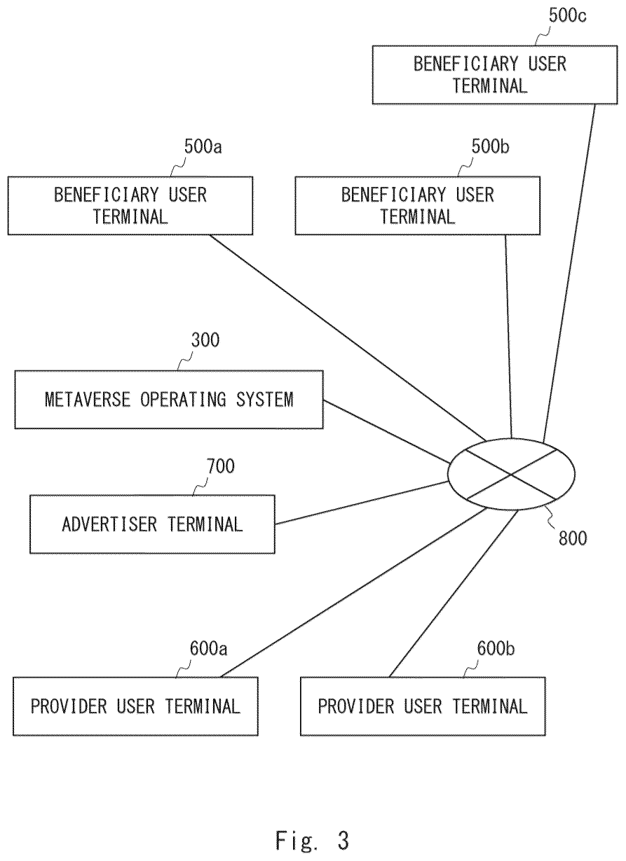

A configuration example of an information processing system in which an information processing apparatus 400 according to the present disclosure is used will be described with reference to FIG. 3. A metaverse operating system 300 is an example of an information processing system in which the information processing apparatus 400 is used. The information processing apparatus 400 is an example of the information processing apparatus 100 described above. The metaverse operating system 300 is an information processing system that holds an event in a metaverse and determines a distribution ratio of advertisement fees paid for the event to each provider. The metaverse operating system 300 is communicatively connected to beneficiary user terminals 500, provider user terminals 600, and an advertiser terminal 700 via a network 800. The network 800 is a network in which information communication apparatuses are connected via wired or wireless communication lines, and may be a network in which only some of information apparatuses can be accessed or a network such as the Internet that can be used by an unidentified number of people.

In the example illustrated in FIG. 3, three beneficiary user terminals 500a, 500b, and 500c are connected to the metaverse operating system 300. The number of the beneficiary user terminals 500 connected to the metaverse operating system 300 is not particularly limited and may be 1 or 2, or may be 4 or more. In the example illustrated in FIG. 3, two provider user terminals 600a and 600b are connected to the metaverse operating system 300. The number of provider user terminals 600 connected to the metaverse operating system 300 is not particularly limited as long as the number of provider user terminals is 2 or more.

The beneficiary user terminal 500 is an information processing terminal used by a beneficiary user and is, for example, a head mounted display (HMD), a personal computer (PC), a smartphone, a tablet terminal, or the like.

The beneficiary user terminal 500 includes an interface or an input interface used for the beneficiary user to input information. The input interface is, for example, a controller in a head mounted display, a touch panel in a smartphone, a keyboard or a mouse in a personal computer, or the like. The controller may incorporate operation buttons and various sensors that detect an orientation and movement of the controller, that is, acceleration, rotation, and the like. By inputting information to the beneficiary user terminal 500 via the input interface, the beneficiary user can move an avatar, switch a viewpoint, and make a speech in the metaverse.

The beneficiary user terminal 500 includes an interface that displays various types of information from the beneficiary user terminal 500 to the beneficiary user, that is, a display interface. The display interface may include, for example, a liquid crystal display. When the beneficiary user terminal 500 is a head mounted display, the display interface is worn on the head of the beneficiary user and covers a field of view of both eyes of the beneficiary user. The beneficiary user wearing the head mounted display can see a video displayed on the display interface. Various pieces of information such as objects and web pages in the metaverse are displayed on the display interface.

The beneficiary user terminal 500 may further include a camera that images the eyes of the beneficiary user. A video captured by the camera may be used to analyze a sight direction of the beneficiary user. The beneficiary user terminal 500 is a computer apparatus that includes a processor and a memory. When the processor in of beneficiary user terminal 500 executes a predetermined program, the beneficiary user terminal 500 performs various processes.

The provider user terminal 600 is an information processing terminal that is used by a provider user and has the same configuration as the beneficiary user terminal 500, and thus description thereof will be omitted.

The advertiser terminal 700 is an information processing terminal that is used by an advertiser who advertises in an event and manages advertisement fees to be paid for the event. The advertiser terminal 700 is a computer apparatus that includes a processor and a memory. When the processor in the advertiser terminal 700 executes a predetermined program, the advertiser terminal 700 performs various processes.

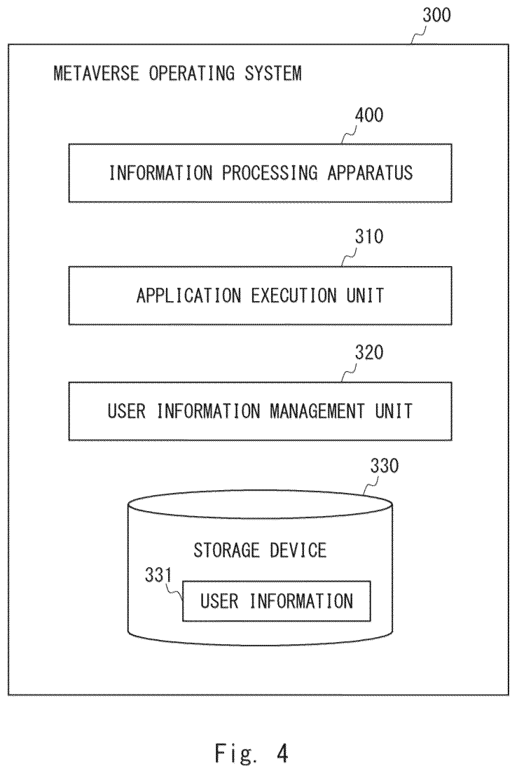

Next, a configuration example of the metaverse operating system 300 will be described with reference to FIG. 4. The metaverse operating system 300 is an information processing system that implements a virtual space of the metaverse and an event in the virtual space. The metaverse operating system 300 includes an information processing apparatus 400, an application execution unit 310, a user information management unit 320, and a storage device 330.

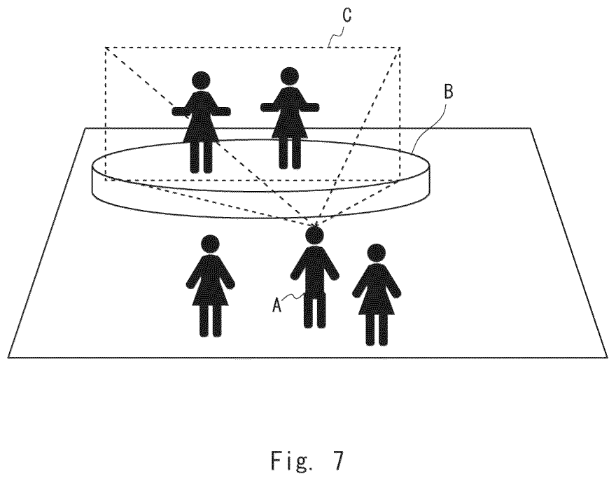

The application execution unit 310 implements a virtual space of the metaverse and manages an operation of an avatar in the virtual space. FIG. 7 illustrates an example of a virtual space implemented by the application execution unit 310. A stage B illustrated in FIG. 7 is a stage constructed in the virtual space. The avatars on the stage B are provider avatars and are performers of an event held in the virtual space. An area C illustrated in FIG. 7 is a screen displayed on the beneficiary user terminal 500 associated with the beneficiary avatar A. In other words, the area C is a field of view of the beneficiary avatar A estimated from the position and a face orientation of the beneficiary avatar A.

Returning back to FIG. 4, the description will be continued. The application execution unit 310 moves the avatars of the beneficiary users and the provider users in the virtual space according to information input to the beneficiary user terminal 500 and the provider user terminal 600. Then, the application execution unit 310 generates a screen displayed on the beneficiary user terminal 500 and the provider user terminal 600 according to the position of the avatar, the face orientation, and the like, and transmits the screen to the beneficiary user terminal 500 and the provider user terminal 600. The beneficiary user terminal 500 and the provider user terminal 600 display the received screen on the display interfaces of the beneficiary user terminal 500 and the provider user terminal 600.

The user information management unit 320 manages user information 331 stored in the storage device 330. The storage device 330 stores the user information 331. The user information 331 is account information of beneficiary users using the virtual space of the metaverse. The user information 331 may include information such as a posture and the face orientation of each of the beneficiary users in the virtual space. The user information 331 may further include information such as a speech history and a chat history. The user information management unit 320 may appropriately acquire information such as a position and a face orientation of each avatar moved by the application execution unit 310 according to information input to the beneficiary user terminal 500 and the provider user terminal 600 as the user information and store the user information in the storage device 330.

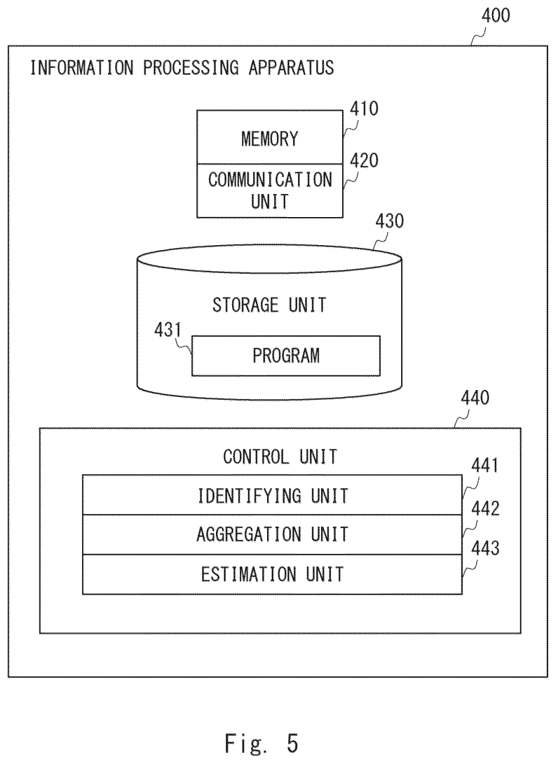

Next, a configuration example of the information processing apparatus 400 will be described with reference to FIG. 5. The information processing apparatus 400 is an information processing apparatus that identifies and aggregates interest states of the beneficiary avatars and estimates a contribution of the provider avatar, and is, for example, a server device implemented by a computer. The information processing apparatus 400 may be redundant for a plurality of servers, and each functional block may be implemented by a plurality of computers. The information processing apparatus 400 includes a memory 410, a communication unit 420, a storage unit 430, and a control unit 440.

The memory 410 is a storage area where processing content of the control unit 440 is temporarily stored and is, for example, a volatile storage device such as a random access memory (RAM). The communication unit 420 is an interface that communicates with the outside of the information processing apparatus 400. The storage unit 430 is a storage device that stores the program 431 and the like. The program 431 is a computer program in which information processing according to the present disclosure is implemented.

The control unit 440 includes an identifying unit 441, an aggregation unit 442, and an estimation unit 443. The control unit 440 is a control device that controls an operation of the information processing apparatus 400 and is, for example, a processor such as a CPU. The control unit 440 reads the program 431 from the storage unit 430 into the memory 410 and executes the program. Accordingly, the control unit 440 implements functions as the identifying unit 441, the aggregation unit 442, and the estimation unit 443.

The identifying unit 441 identifies an interest state of each beneficiary avatar based on a position and a face orientation of each of the beneficiary avatars moved by the application execution unit 310 in the virtual space. In the example illustrated in FIG. 7, a field of view of the beneficiary avatar A includes two provider avatars. In this case, the identifying unit 441 may identify that the beneficiary user associated with the beneficiary avatar A is in the interest state in which the two provider avatars are paid attention. The identifying unit 441 may identify that the beneficiary user is in the interest state when the provider avatar is included in the field of view of the beneficiary user continuously for a predetermined time or more.

The aggregation unit 442 counts the interest state for each provider avatar with respect to the specific state identified by the identifying unit 441. For example, the aggregation unit 442 may aggregate an index indicating the interest state of each beneficiary avatar for each provider avatar. Here, the index indicating the interest state is a numerical value indicating the interest state and is, for example, a length of time in which the interest state continues. The aggregation unit 442 may aggregate the interest state after assigning a weight to the index indicating the interest state when a predetermined condition is satisfied. Here, examples of the predetermined condition include whether the beneficiary user is speaking or chatting in the interest state. For example, when a history of chatting by the beneficiary user remains in the interest state, the aggregation unit 442 may aggregate the interest state by assigning a weight to the interest state with chat history than the interest state with no chat history remaining. When content of the chat by the beneficiary user in the interest state is favorable to the provider avatar, the aggregation unit 442 may weigh the interest state more heavily.

The estimation unit 443 estimates a contribution to the event for each provider avatar based on the interest state aggregated by the aggregation unit 442. The interest state aggregated by the aggregation unit 442 is indicated by a numerical value, and the estimation unit 443 estimates a contribution of each beneficiary avatar according to magnitude of the numerical value. For example, when the length of time in which the interest state continues is used as an index indicating the interest state, the estimation unit 443 estimates that the provider avatar that has a large numerical value of the interest state aggregated by the aggregation unit 442 has a large contribution to the event.

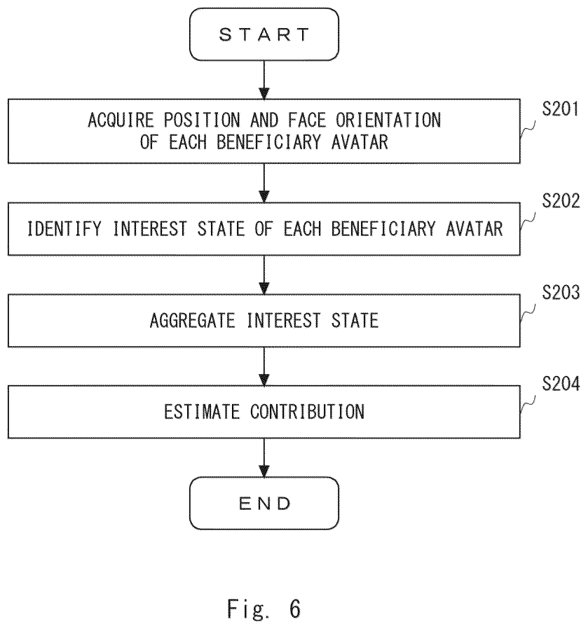

Next, an operation example of the information processing apparatus 400 will be described with reference to FIG. 6. First, the identifying unit 441 acquires the position and the face orientation in the virtual space of each beneficiary avatar moved by the application execution unit 310 (step S201). In step S201, the identifying unit 441 may directly acquire the position and the face orientation of each of the beneficiary avatars in the virtual space from the application execution unit 310 or the storage device 330. Subsequently, the identifying unit 441 identifies the interest state of each of the beneficiary avatars based on the position and the face orientation of each of the beneficiary avatars acquired in step S201 in the virtual space (step S202).

Subsequently, the aggregation unit 442 aggregates the interest state identified in step S202 for each provider avatar (step S203). In step S203, the aggregation unit 442 may aggregate the interest state after assigning a weight to the index indicating the interest state. Subsequently, the estimation unit 443 estimates the contribution to the event for each provider avatar based on the interest state aggregated in step S203 (step S204). In this way, the information processing apparatus 400 can estimate a contribution to the event for each provider avatar based on the interest state aggregated for each provider avatar. Therefore, the advertisement fees received from the advertiser associated with the advertiser terminal 700 can be distributed according to the contribution of each provider user.

### Third Example Embodiment

In the above-described configuration example, the case where the identifying unit 441 identifies the interest state based on the position and the face orientation of each beneficiary avatar has been described. However, a method in which the identifying unit 441 identifies the interest state is not limited thereto. For example, the identifying unit 441 may identify the interest state based on the field of view of each beneficiary user. In this case, the identifying unit 441 acquires the field of view of each beneficiary user from each beneficiary user terminal 500 and identifies the interest state based on the field of view. The identifying unit 441 may acquire a field of view including the field of view of interest. The field of view of interest is an area to which the user particularly pays attention in the field of view and may be, for example, a central portion of the field of view. The field of view of interest may be in a plurality of stages. For example, the field of view of interest may be an area in which the user further pays attention to the central portion than the peripheral portion.

When the beneficiary user terminal 500 further includes a camera that images the eyes of the beneficiary user, the identifying unit 441 may acquire imaged data obtained by imaging the eyes of the beneficiary user or a field of view including the field of view of interest estimated based on the data. In this case, the identifying unit 441 identifies the interest state using an area corresponding to a destination of the sight of the beneficiary user as the field of view of interest.

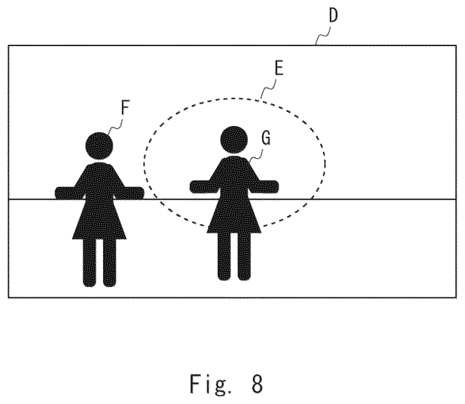

FIG. 8 is an example of a field of view of the beneficiary user. A field of view D illustrated in FIG. 8 is a field of view viewed by the beneficiary user. The field of view of interest E is the field of view of interest of the beneficiary user. In the example illustrated in FIG. 8, a field of view E of interest includes a provider avatar G and does not include a provider avatar F. In such a case, the identifying unit 441 may identify an interest state in which the provider avatar G is paid attention.

The identifying unit 441 may identify a case where a face portion of the provider avatar is included in the field of view of interest as the interest state. The identifying unit 441 may identify a case where the face portion of the provider avatar is included in the field of view of interest for a predetermined time or more as the interest state. The identifying unit 441 preferably acquires the field of view including the field of view of interest from the beneficiary user terminal 500 used by the beneficiary user who has agreed to use the field of view of interest.

When the identifying unit 441 identifies the interest state based on the field of view including the field of view of interest, the aggregation unit 442 may aggregate the interest state after assigning a weight to an index indicating the interest state according to the length of time in which the provider avatar is included in the field of view of interest. For example, the aggregation unit 442 may assign a weight to the index indicating the interest state such that the weighting becomes heavier as the time in which the provider avatar is included in the attention field becomes longer.

The identifying unit 441 may identify parts of the provider avatar included in the field of view of interest. In this case, the aggregation unit 442 aggregates the interest state for each part of each provider avatar. In this way, by identifying and aggregating the interest state for each part of the provider avatar, it is possible to ascertain to which part of the provider avatar the beneficiary user particularly pays attention.

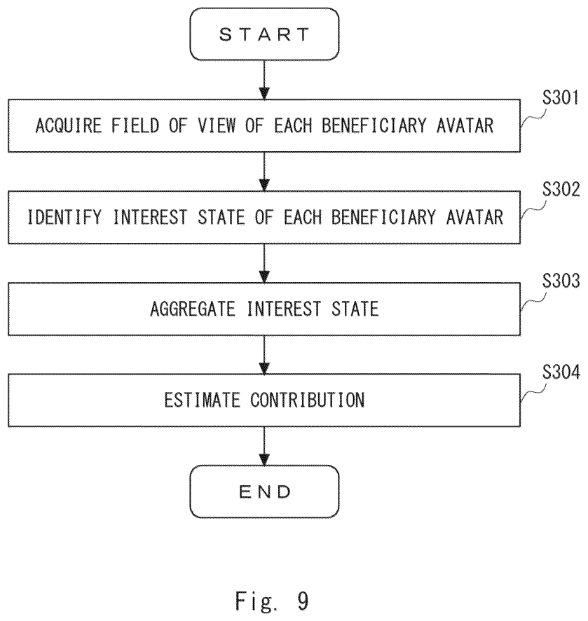

Next, an operation example of the information processing apparatus 400 will be described with reference to FIG. 9. First, the identifying unit 441 acquires a field of view including the field of view of interest from the beneficiary user terminal 500 (step S301). Subsequently, the identifying unit 441 identifies the interest state of each beneficiary avatar based on the field of view acquired in step S301 (step S302). Subsequently, the aggregation unit 442 aggregates the interest state identified in step S302 for each provider avatar (step S303). Subsequently, the estimation unit 443 estimates the contribution to the event for each provider avatar based on the interest state aggregated in step S303 (step S304).

### Example of Hardware Configuration

Hereinafter, a case where each functional configuration of the information processing apparatus according to the present disclosure is implemented by combining hardware and software will be described.

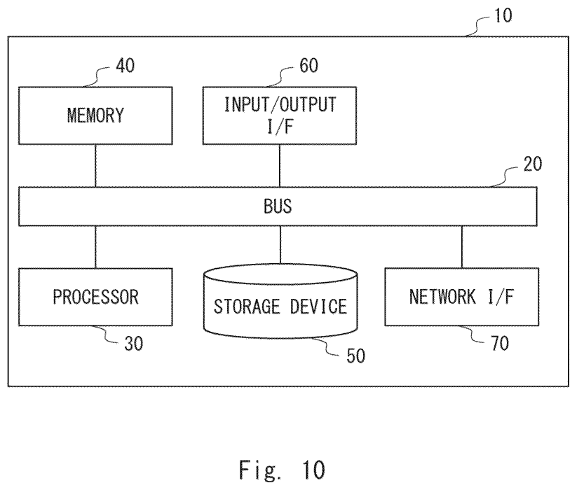

FIG. 10 is a block diagram illustrating a hardware configuration of a computer. The information processing apparatus according to the present disclosure can implement the above-described functions by the computer 10 including the hardware configuration illustrated in FIG. 10. The computer 10 may be a portable computer such as a smartphone or a tablet terminal or may be a stationary computer such as a PC. The computer 10 may be a dedicated computer designed to implement each device or a general-purpose computer. The computer 10 can implement a desired function by installing a predetermined program.

The computer 10 includes a bus 20, a processor 30, a memory 40, a storage device 50, an input/output interface 60 (an interface is also abbreviated to an I/F), and a network interface 70. The bus 20 is a data transmission path used for the processor 30, the memory 40, the storage device 50, the input/output interface 60, and the network interface 70 to transmit and receive data to and from each other. Here, a method of connecting the processor 30 and the like to each other is not limited to the bus connection.

The processor 30 is any of various processors such as a CPU, a GPU, or an FPGA. The memory 40 is a main storage device implemented using a random access memory (RAM) or the like.

The storage device 50 is an auxiliary storage device implemented using a hard disk, an SSD, a memory card, a read only memory (ROM), or the like. The storage device 50 stores a program for implementing a desired function. The processor 30 reads the program into the memory 40 and executes the program to implement each functional component of each device.

The input/output interface 60 is an interface for connecting the computer 10 and an input/output device. For example, an input device such as a keyboard or an output device such as a display device are connected to the input/output interface 60.

The network interface 70 is an interface for connecting the computer 10 to a network.

Although the example of the hardware configuration in the present disclosure has been described above, the above-described example embodiment is not limited thereto. According to the present disclosure, any process can also be implemented by causing a processor to execute a computer program.

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as in the following supplementary notes, but are not limited to the following supplementary notes.

### Supplementary Note A1

An information processing apparatus comprising:
identifying means for identifying, in an event in which a plurality of provider avatars providing a predetermined benefit in a virtual space provide the benefit to a beneficiary avatar receiving the benefit, an interest state in which the beneficiary avatar pays attention to a provider avatar;
aggregation means for aggregating the interest state for each of the provider avatars; and
estimation means for estimating a contribution of the provider avatar to the event based on the aggregated interest state.

### Supplementary Note A2

The information processing apparatus according to Supplementary Note A1, wherein the identifying means identifies the interest state when the provider avatar is included in a field of view of the beneficiary avatar for a predetermined period of time or more.

### Supplementary Note A3

The information processing apparatus according to Supplementary Note A1 or A2, wherein the identifying means identifies the interest state when a facial portion of the provider avatar is included in a predetermined field of view in a field of view of the beneficiary avatar includes for a predetermined period of time or more.

### Supplementary Note A4

The information processing apparatus according to any one of Supplementary Notes A1 to A3, wherein the aggregation means assigns a weight to an index indicating the interest state in accordance with a length of time in which the provider avatar is included in a predetermined field of view in a field of view of the beneficiary avatar, and then aggregates the interest state.

### Supplementary Note A5

The information processing apparatus according to any one of Supplementary Notes A1 to A4, wherein the identifying means identifies the provider avatar in which the beneficiary avatar is interested based on a face orientation of the beneficiary avatar.

### Supplementary Note A6

The information processing apparatus according to Supplementary Note A3 or A4, wherein the identification means identifies the interest state using the field of view of interest of the beneficiary avatar obtaining consent to utilize the field of view of interest from a user associated with the beneficiary avatar.

### Supplementary Note A7

The information processing apparatus according to any one of Supplementary Notes A1 to A6, wherein the aggregation means aggregates the interest state using content of a speech or a chat of the beneficiary avatar for weighting an index indicating the interest state in the aggregation of the interest state.

### Supplementary Note A8

The information processing apparatus according to Supplementary Note A3 or A4, in which
the identifying means identifies parts of the provider avatar included in the field of view of interest, and
the aggregation means aggregates the interest state for each of the parts of the provider avatar.

### Supplementary Note A9

The information processing apparatus according to any one of Supplementary Notes A1 to A8, wherein
the identifying means identifies an interest state in which each of a plurality of the beneficiary avatars pays attention to the provider avatar, and
the aggregation means aggregates the interest state of each of the beneficiary avatars for each of the provider avatars.

### Supplementary Note B1

An information processing method comprising: by the computer,
identifying, in an event in which a plurality of provider avatars providing a predetermined benefit in a virtual space provide the benefit to a beneficiary avatar receiving the benefit, an interest state in which the beneficiary avatar pays attention to a provider avatar;
aggregating the interest state for each of the provider avatars by; and
estimating a contribution of the provider avatar to the event based on the aggregated interest state.

### Supplementary Note C1

An information processing program causing a computer to perform:
a process of identifying, in an event in which a plurality of provider avatars providing a predetermined benefit in a virtual space provide the benefit to a beneficiary avatar receiving the benefit, an interest state in which the beneficiary avatar pays attention to a provider avatar;
a process of aggregating the interest state for each of the provider avatars; and
a process of estimating a contribution of the provider avatar to the event based on the aggregated interest state.

Some or all of the elements (for example, configurations and functions) described in Supplementary Notes A2 to A9 dependent on Supplementary Note A1 can also be dependent on Supplementary Notes B1 and C1 by the same dependency relationship as Supplementary Notes A2 to A9. Some or all of the elements described in any supplementary note may be applied to various types of hardware, software, recording means for recording software, systems, and methods.

What is claimed is:

1. An information processing apparatus comprising:
at least one memory configured to store instructions; and
at least one processor configured to execute the instructions to
identify, in an event in which a plurality of provider avatars providing a predetermined benefit in a virtual space provide the benefit to a beneficiary avatar receiving the benefit, an interest state in which the beneficiary avatar pays attention to a provider avatar,
aggregate the interest state for each of the provider avatars, and
estimate a contribution of the provider avatar to the event based on the aggregated interest state.

2. The information processing apparatus according to claim 1, wherein the at least one processor executes the instructions to identify the interest state when the provider avatar is included in a field of view of the beneficiary avatar for a predetermined period of time or more.

3. The information processing apparatus according to claim 1, wherein the at least one processor executes the instructions to identify the interest state when a facial portion of the provider avatar is included in a predetermined field of view in a field of view of the beneficiary avatar for a predetermined period of time or more.

4. The information processing apparatus according to claim 1, wherein the at least one processor executes the instructions to assign a weight to an index indicating the interest state in accordance with a length of time in which the provider avatar is included in a predetermined field of view in a field of view of the beneficiary avatar, and then aggregate the interest state.

5. The information processing apparatus according to claim 1, wherein the at least one processor executes the instructions to identify the provider avatar in which the beneficiary avatar is interested based on a face orientation of the beneficiary avatar.

6. The information processing apparatus according to claim 3, wherein the at least one processor executes the instructions to identify the interest state using the field of view of interest of the beneficiary avatar who has agreed to use the field of view of interest from a user associated with the beneficiary avatar.

7. The information processing apparatus according to claim 1, wherein the at least one processor executes the instructions to aggregate the interest state using content of a speech or a chat of the beneficiary avatar for weighting an index indicating the interest state in the aggregation of the interest state.

8. The information processing apparatus according to claim 3, wherein the at least one processor executes the instructions to identify parts of the provider avatar included in the field of view of interest and aggregate the interest state for each of the parts of the provider avatar.

9. An information processing method comprising: by a computer,
identifying, in an event in which a plurality of provider avatars providing a predetermined benefit in a virtual space provide the benefit to a beneficiary avatar receiving the benefit, an interest state in which the beneficiary avatar pays attention to a provider avatar;
aggregating the interest state for each of the provider avatars; and
estimating a contribution of the provider avatar to the event based on the aggregated interest state.

10. An information processing program causing a computer to perform:
a process of identifying, an event in which a plurality of provider avatars providing a predetermined benefit in a virtual space provide the benefit to a beneficiary avatar receiving the benefit, an interest state in which the beneficiary avatar is paying attention to a provider avatar;
a process of aggregating the interest state for each of the provider avatars; and
a process of estimating a contribution of the provider avatar to the event based on the aggregated interest state.
